(19) United States
(12) Patent Application Publication
(10) Pub. No.: US 2026/0187526 A1
(43) Pub. Date: Jul. 2, 2026

(54) PROTECTION OF SENSITIVE INFORMATION IN MACHINE LEARNING MODELS

(71) Applicant: International Business Machines Corporation, Armonk, NY (US)

(72) Inventors: Yu Long Zhang, Beijing (CN); Mai Zeng, Beijing (CN); Ji Dong Li, Beijing (CN); Peng Hui Jiang, Beijing (CN)

(21) Appl. No.: 19/007,743

(22) Filed: Jan. 2, 2025

(51) Int. Cl. G06N 20/00

(52) U.S. Cl. CPC G06N 20/00

(57) ABSTRACT

According to an embodiment of the present invention, a computer system partitions a training data set for a machine learning model into a plurality of categories. Data from the plurality of categories is extracted based on density of data elements in the plurality of categories to produce a resulting data set. The resulting data set is divided into a plurality of blocks based on a probability of deletion of data elements in the resulting data set. The machine learning model is incrementally trained using segments from the blocks. Information is removed from the machine learning model by retraining the machine learning model with subsequent data in a corresponding block containing the information to be removed. Embodiments of the present invention further include a method and computer program product for removing information from a machine learning model in substantially the same manner described above.

### BACKGROUND

### 1. Technical Field

Present invention embodiments relate to machine learning, and more specifically, to removing sensitive information (e.g., personal information (e.g., personally identifiable information (PII), etc.), financial information, health information (e.g., protected health information (PHI), etc.), confidential or proprietary information, etc.) from machine learning models with reduced training.

### 2. Discussion of the Related Art

Machine learning is the foundation of popular Internet services, such as image and speech recognition and natural language translation. Many companies also use machine learning internally to improve marketing and advertising, recommend products and services to users, or better understand the data generated by their operations. In these scenarios, activities of individual users are used as the training data (e.g., purchases and preferences, health data, online and offline transactions, photos, commands spoken into mobile phones, and locations traveled).

As artificial intelligence (AI) becomes increasingly data-dependent, more and more factors, such as privacy concerns, regulations, and laws, are leading to a new type of request to delete information. Specifically, concerned parties are requesting that particular samples be removed from a training data set and that the impact of those samples be removed from an already trained machine learning model. For already trained machine learning models, just deleting the original data is not enough because the machine learning model can memorize the original data. After deleting the data, the machine learning model needs to be retrained, but the cost of retraining is very high. Although there are some related techniques, these are limited to special machine learning methods and cannot be widely adopted.

### SUMMARY

According to an embodiment of the present invention, a computer system comprises a processor set, one or more computer-readable storage media, and program instructions stored on the one or more computer-readable storage media. The system partitions a training data set for a machine learning model into a plurality of categories. Data from the plurality of categories is extracted based on density of data elements in the plurality of categories to produce a resulting data set. The resulting data set is divided into a plurality of blocks based on a probability of deletion of data elements in the resulting data set. The machine learning model is incrementally trained using segments from the blocks. Information is removed from the machine learning model by retraining the machine learning model with subsequent data in a corresponding block containing the information to be removed. Embodiments of the present invention further include a method and computer program product for removing information from a machine learning model in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of machine learning data protection code for removing information from machine learning models according to an embodiment of the present invention.

FIG. 3 is a procedural flowchart of a method of removing sensitive information from a machine learning model according to an embodiment of the present invention.

FIG. 4 is a flow diagram of a manner of removing sensitive information from a machine learning model according to an embodiment of the present invention.

FIG. 5 is a flow diagram of a manner of partitioning a data set into categories according to an embodiment of the present invention.

FIG. 6 is a flow diagram of a manner of extracting representative data from categories of a data set according to an embodiment of the present invention.

FIG. 7A is a procedural flowchart of a method of extracting representative data from categories according to an embodiment of the present invention.

FIG. 7B is example pseudocode of a method for extracting representative data from categories according to an embodiment of the present invention.

FIG. 8 is a flow diagram of a manner of partitioning representative data of categories into blocks according to an embodiment of the present invention.

FIG. 9A is a procedural flowchart of a method of partitioning representative data of categories into blocks according to an embodiment of the present invention.

FIG. 9B is example pseudocode of a method of partitioning representative data of categories into blocks according to an embodiment of the present invention.

FIG. 10 is a flow diagram of a manner of incrementally training a machine learning model to remove sensitive information according to an embodiment of the present invention.

FIG. 11 is a flow diagram of a manner of removing sensitive information from a machine learning model according to an embodiment of the present invention.

### DETAILED DESCRIPTION

An embodiment of the present invention provides a framework to delete specified sample data from a training set and reduce retraining data to remove the specified sample data from a machine learning model. Since some of the original data have labels and some do not, a k-means clustering algorithm is used to initially partition or classify the data. Each cluster represents a category, which effectively avoids the inability to classify the data because it has no labels. The densest points of each cluster are used as a representative block. Sparse blocks are removed as useless blocks and the representative blocks are extracted from categories to form new clusters that are used to form a new data set. This reduces the data and time for retraining the machine learning model. The extraction is based on a conventional density-based spatial clustering of applications with noise (DBSCAN) algorithm that has been modified for performing the extraction. The new data set is sorted according to a probability of deletion (or sensitivity of data), and partitioned into blocks or shards. When an expectation value and variance for a block or shard are greater than corresponding thresholds, the next blocks or shards are allocated. During training, the parameters and machine learning model of each slice of the blocks is saved in a database. When retraining is to be performed, the training starts subsequent the corresponding position in the block of the data requested to be removed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

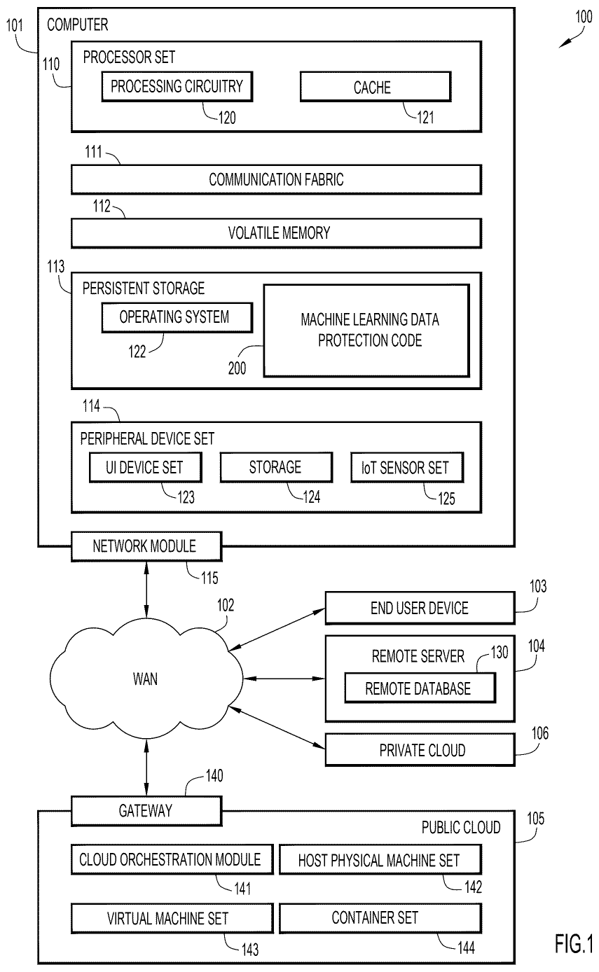

Referring to FIG. 1, computing environment 100 contains an example of an environment for the execution of at least some of the computer code involved in performing the inventive methods, such as machine learning data protection code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): public and private clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offerings is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

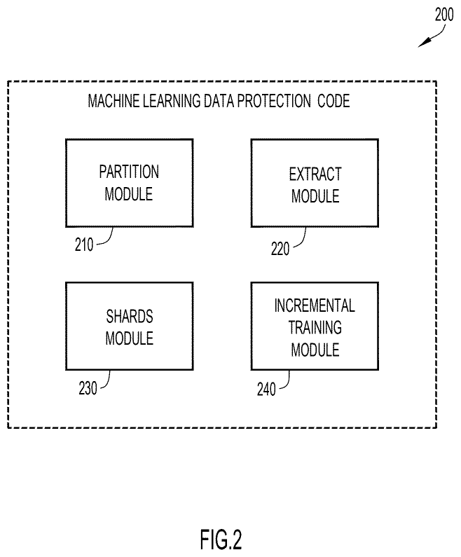

Machine learning data protection code 200 according to an embodiment of the present invention is illustrated in FIG. 2. Machine learning data protection code 200 includes a partition module 210, an extract module 220, a shards module 230, and an incremental training module 240. Partition module 210 partitions or classifies original (training) data into categories or classes to avoid affecting categories with small data volumes. Since some of the original data have labels and some do not, a k-means clustering algorithm may be used to initially classify the original data. Each cluster represents a category or class, which effectively avoids the inability to classify the data because it has no labels.

Extract module 220 selects representative data in each category. The densest points of each category are used as a representative block. Sparse blocks are removed as useless blocks and the representative blocks are extracted from the categories to form new clusters that are used to form a new data set. This reduces the data and time for retraining the machine learning model. The extraction may be based on a conventional density-based spatial clustering of applications with noise (DBSCAN) algorithm that has been modified for performing the extraction as described below.

Shards module 230 divides the new data set into blocks (or shards) to better reduce the data used for retraining a machine learning model. The new data set is sorted according to a probability of deletion (or sensitivity of data), and partitioned into blocks (or shards). When an expectation value and variance for a block (or shard) are greater than corresponding thresholds, the next blocks (or shards) are allocated. Sensitive data with high probability of deletion should be allocated to one block as much as possible to reduce the number of repeated training blocks.

Incremental training module 240 performs incremental training and stores the parameters and machine learning model of each step of training in a database. During training, the parameters and machine learning model of each slice of the blocks is saved in the database. When retraining is to be performed, the training starts subsequent the corresponding position in the block of the data requested to be removed. Thus, there is no need to train with all data within the block. Rather, training is performed from the position of the removed data.

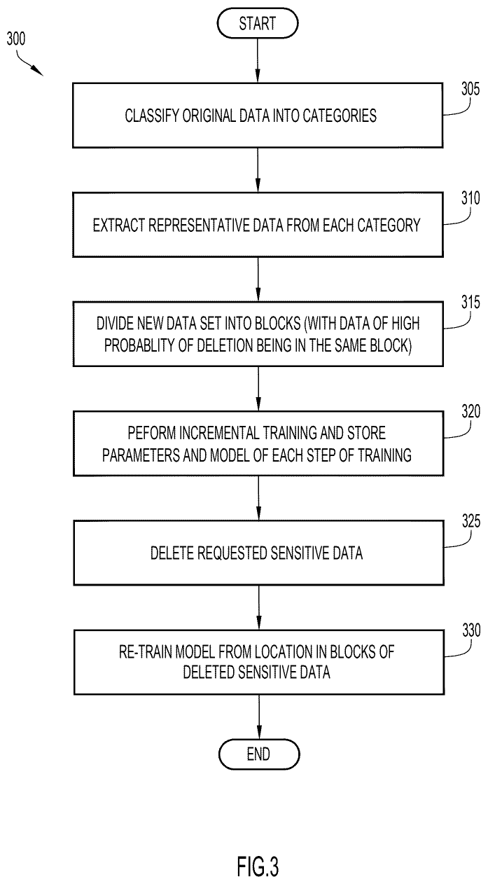

A method 300 of removing sensitive information from a machine learning model (e.g., via machine learning data protection code 200, computer 101, etc.) according to an embodiment of the present invention is illustrated in FIG. 3. Initially, partition module 210 partitions or classifies original (training) data into categories or classes at operation 305. Since some of the original data have labels and some do not, a conventional or other k-means clustering technique may be used to classify the original data, where each resulting cluster represents a category or class.

Extract module 220 selects representative data in each category at operation 310. The densest points of each category are used as a representative block, and the representative blocks from the categories are extracted to form new clusters that are used to form a new data set. The extraction is based on a conventional density-based spatial clustering of applications with noise (DBSCAN) algorithm that has been modified for performing the extraction as described below.

Shards module 230 divides the new data set into blocks (or shards) at operation 315. The blocks (or shards) may include any quantity of data elements. The new data set is sorted according to a probability of deletion (or sensitivity of data), and partitioned into the blocks (or shards). Sensitive data with high probability of deletion should be allocated to one block as much as possible to reduce the number of repeated training blocks.

Incremental training module 240 performs incremental training and stores the parameters and machine learning model of each step of training in a database at operation 320. A request to remove sensitive data or information (e.g., personal information (e.g., personally identifiable information (PII), etc.), financial information, health information (e.g., protected health information (PHI), etc.), confidential or proprietary information, etc.) is received and the sensitive data is removed from one or more blocks at operation 325.

The machine learning model is retrained subsequent a location in the blocks of the deleted sensitive data at operation 330. During training, incremental training is used in each block. The training parameters and machine learning model of each slice or segment of a block are stored in a database. The slice may include any quantity of data elements of the block, and each block may include any quantity of slices. When retraining is to be performed, the training is performed with a machine learning model trained from a block with data prior to the sensitive data requested to be removed. This machine learning model is retrained starting with data subsequent the corresponding position in the block of the sensitive data requested to be removed (thereby omitting the sensitive data from retraining). Thus, there is no need to train with all data within the block. Rather, training is performed from the position of the removed data. In other words, when a user desires to delete a piece of sensitive data, there is no need to use all the remaining data of a block. The machine learning model may be retrained with data subsequent the position in a block where the sensitive data is located.

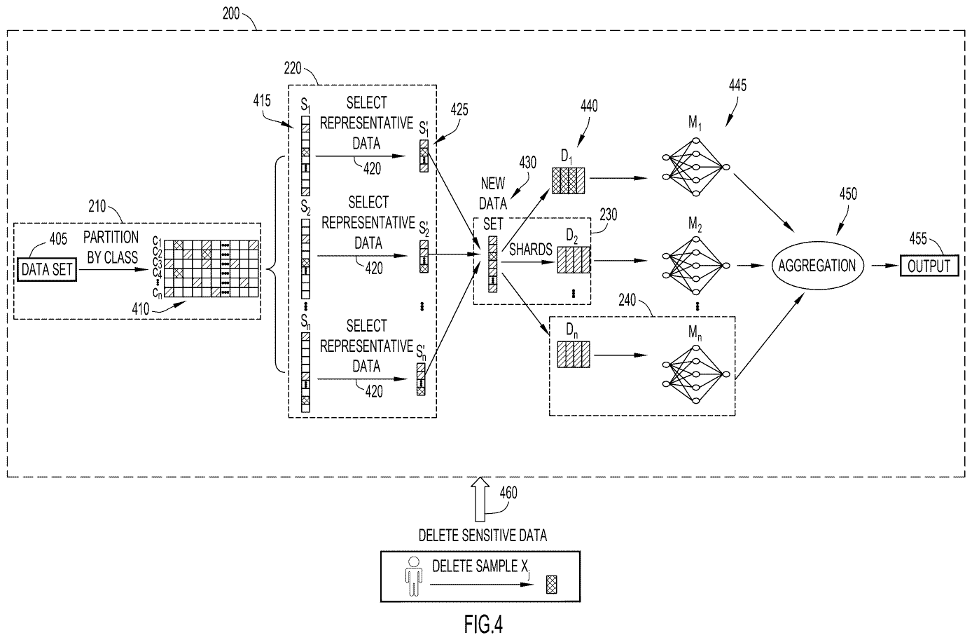

A manner of removing sensitive information from a machine learning model (e.g., via machine learning data protection code 200, computer 101, etc.) according to an embodiment of the present invention is illustrated in FIG. 4. Initially, partition module 210 partitions or classifies original (training) data 405 into categories or classes 410. Since some of the original data have labels and some do not, a conventional or other k-means clustering technique may be used to classify the original data, where each resulting cluster represents a category or class.

Extract module 220 selects representative data 420 in each category 415. The densest points of each category are used as a representative block, and the representative blocks from the categories are extracted to form new clusters 425 that are used to form a new data set 430. The extraction is based on a conventional density-based spatial clustering of applications with noise (DBSCAN) algorithm that has been modified for performing the extraction as described below.

Shards module 230 sorts new data set 430 according to a probability of deletion (or sensitivity of data) and divides the sorted new data set into blocks (or shards) 440 (e.g., D₁ to Dₙ as viewed in FIG. 4). Sensitive data with high probability of deletion should be allocated to one block as much as possible to reduce the number of repeated training blocks.

Incremental training module 240 performs incremental training for machine learning models 445 (e.g., M₁ to Mₙ as viewed in FIG. 4) using data from a corresponding block 440, and stores parameters and the machine learning model of each step of training in a database (e.g., database 130, etc.). Machine learning models 445 may include any conventional or other machine learning models (e.g., mathematical/statistical, classifiers, feed-forward, recurrent, convolutional, deep learning, or other neural networks, large language models (LLM), etc.). By way of example, machine learning models 445 may include one or more neural networks. For example, neural networks may include an input layer, one or more intermediate layers (e.g., including any hidden layers), and an output layer. Each layer includes one or more neurons, where the input layer neurons receive input (e.g., data or features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various example data, features, and/or information as input and corresponding desired outputs, where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output. The output with the highest probability may be selected as the result.

A request 460 to delete or remove sensitive data (e.g., personal information (e.g., personally identifiable information (PII), etc.), financial information, health information (e.g., protected health information (PHI), etc.), confidential or proprietary information, etc.) is received and the sensitive data is identified in blocks 440. The corresponding machine learning model is retrained from a location in the blocks subsequent the deleted sensitive data as described herein.

Machine learning models 445 are combined or aggregated (e.g., machine learning models, parameters, etc.) by an aggregator 450 and the resulting machine learning model (e.g., retrained to remove the sensitive data) is provided as output 455. Aggregator 450 may select an appropriate machine learning model, and/or combine weights and/or other parameters of the machine learning models (e.g., average or other statistical measure of the weights or parameters, select min or max values, etc.) to produce a resulting machine learning model having the sensitive data removed.

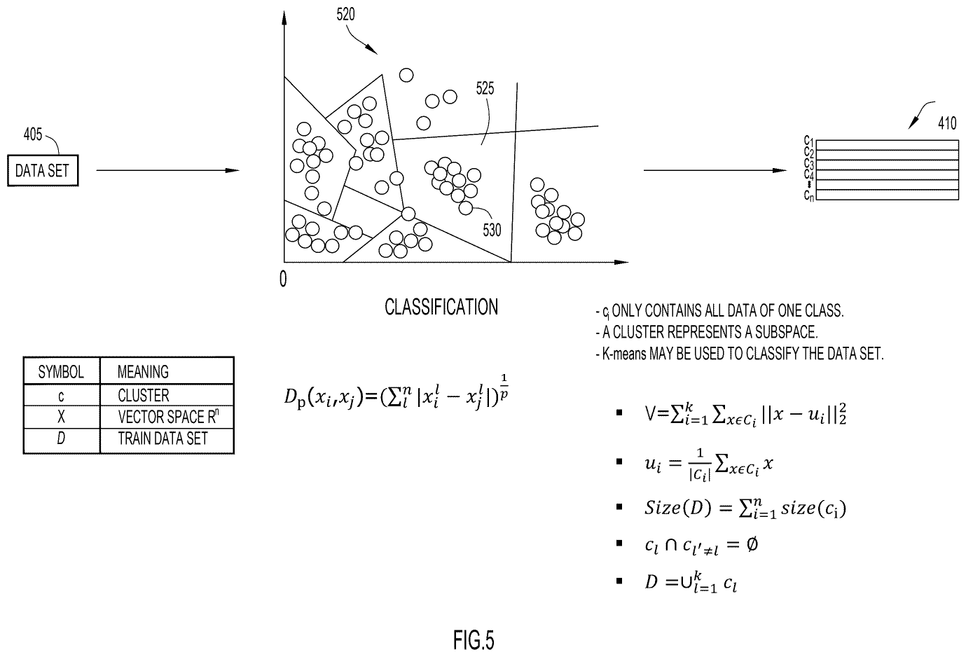

A manner of classifying a data set into categories (e.g., via partition module 210, computer 101, etc.) according to an embodiment of the present invention is illustrated in FIG. 5. This may correspond to operation 305 of FIG. 3. Initially, partition module 210 partitions or classifies original (training) data 405 into categories or classes 410. Since some of the original data have labels and some do not, a conventional or other k-means clustering technique may be used to classify the original data, where each resulting cluster represents a category or class. Original data 405 are basically projected onto a multidimensional space 520 (e.g., via k-means clustering techniques) with areas or subspaces 525 each including groups of data elements 530 from original data 405. Areas 525 serve as the clusters each representing a category or class. The classifying of the original data set avoids accidentally deleting categories with small amounts of data.

The clusters are preferably formed to minimize a sum of squares or variance (e.g., V as viewed in FIG. 5) within each cluster, and with each data element of data set 405 residing once among the clusters (e.g., each data element is assigned to one cluster). The expressions, constraints, and other parameters for the clusters and data set are shown in FIG. 5.

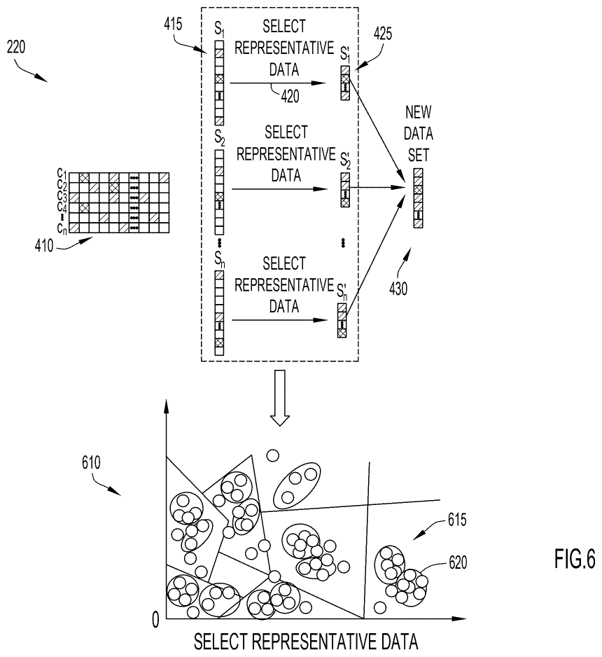

A manner of extracting representative data from categories of a data set (e.g., via extract module 220, computer 101, etc.) according to an embodiment of the present invention is illustrated in FIG. 6. Initially, partition module 210 partitions or classifies original (training) data 405 into categories or classes 410 in substantially the same manner described above. Extract module 220 selects representative data 420 in each category 415 of categories 410. The densest points of each category are used as a representative block to form new clusters 425. The new clusters from the categories are extracted and used to form a new data set 430.

Categories 415 are basically projected onto a multidimensional space 610 with areas or subspaces 615 each representing a cluster or category 415 and including groups of data elements 620. A group is selected from each area 615 (or category) to serve as the representative block. By way of example, the selection or extraction is based on a conventional density-based spatial clustering of applications with noise (DBSCAN) algorithm that has been modified as described below.

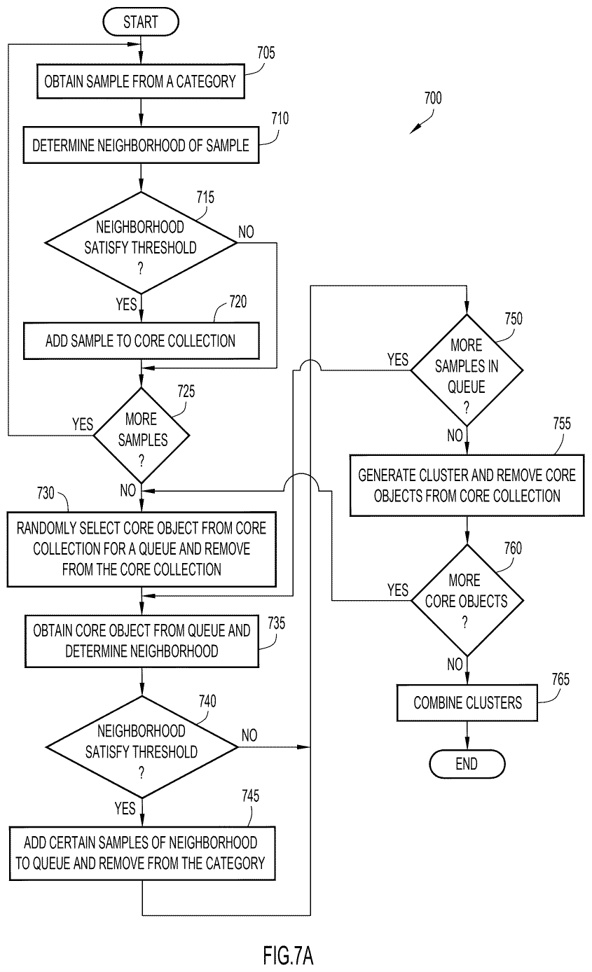

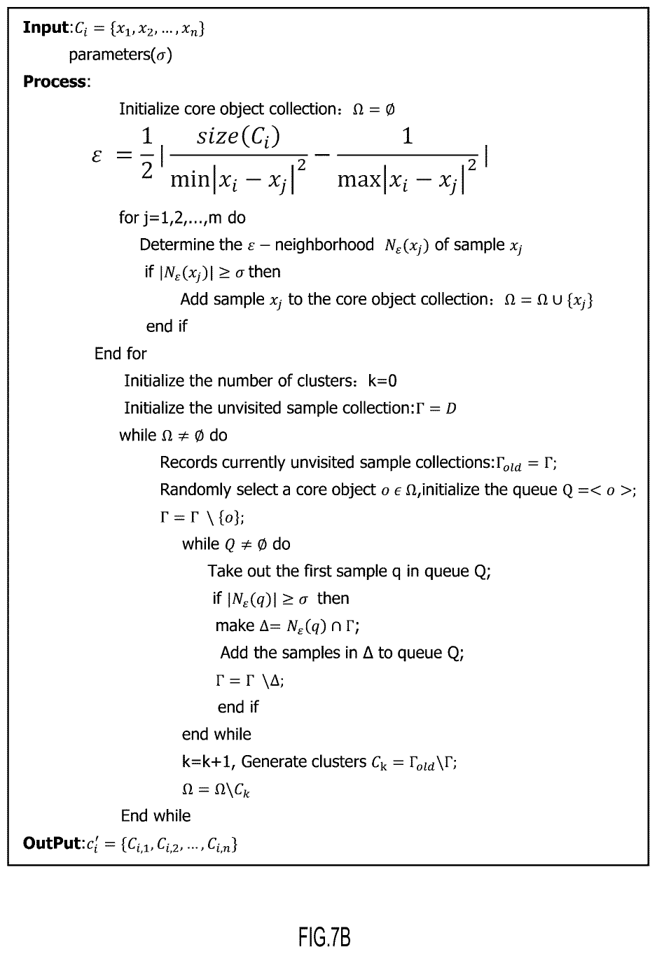

A method 700 for extracting representative data from categories (e.g., via extract module 220, computer 101, etc.) according to an embodiment of the present invention is illustrated in FIG. 7A. This may correspond to operation 310 of FIG. 3. Basically, data screening is performed for each category of data using a density technique to delete points with sparse density (e.g., few neighbors, etc.). A core object or data element in a category is selected as a seed data element and the corresponding clusters of representative data are determined based on the seed data element.

By way of example, the density technique is based on a conventional density-based spatial clustering of applications with noise (DBSCAN) algorithm that has been modified. Since a neighborhood or distance value, ε, in the conventional DBSCAN algorithm is set based on experience, which requires strong experience of a user, an embodiment of the present invention modifies the DBSCAN algorithm by setting the neighborhood or distance value, ε, to a maximum density and minimum density between densities.

Specifically, a sample data element is obtained from a category at operation 705, and a neighborhood for the sample data element is determined at operation 710. The sample data element may include any quantity of data from an item in the category (e.g., record, file, entry, etc.). The neighborhood includes data elements of the category within the distance, ε, from the sample data element. By way of example, the neighborhood or distance value, ε, may be expressed as:
ε=½|[size (Cᵢ)/min|xᵢ−xⱼ|²]−[1/max|xᵢ−xⱼ|²]|, where xᵢ represents a current data element, xⱼ represents another data element, C represents a category, size (Cᵢ) represents a number of data elements in the category, min represents a minimum function, and max represents a maximum function.

When the number of data elements in the neighborhood (or within distance ε) of the sample data element satisfies a threshold (e.g., greater than or equal to a neighborhood threshold, etc.) as determined at operation 715, the sample data element is considered a core object and added to a core collection at operation 720. The core collection basically represents seed data elements for forming clusters (containing the representative data elements of the category). The above process is repeated from operation 705 until the data elements of the category have been processed as determined at operation 725.

Once the core objects or seed data elements are determined, a core object (or seed data element) is randomly selected for a queue or other list at operation 730. The selected core object is also removed from the core collection (to avoid reprocessing of the selected core object). A core object is obtained from the queue at operation 735 and a neighborhood for the selected core object is determined at operation 735. The neighborhood includes data elements of the category within the distance, ε, from the selected core object.

When the number of data elements in the neighborhood (or within distance ε) of the selected core object satisfies a threshold (e.g., greater than or equal to the neighborhood threshold, etc.) as determined at operation 740, certain data elements in the neighborhood of the selected core object are added to the queue and removed from the category at operation 745. By way of example, data elements within the category that are in the neighborhood (or distance ε) of the selected core object are added to the queue. The above process is repeated from operation 735 until the core objects in the queue have been processed as determined at operation 750.

Once the core objects in the queue have been processed, a cluster is generated at operation 755 and includes the core objects in the queue and their neighbors (e.g., data elements in the category having sufficient density based on the number of neighbors). The core objects of the cluster are also removed from the core collection (to avoid processing of the core objects). The above process is repeated from operation 730 to generate additional clusters until the core objects in the core collection have been processed as determined at operation 760. The generated clusters are combined to form a resulting cluster with the representative data elements for the category as shown at operation 765. Each category may be processed in substantially the same manner described above to extract representative data elements from the clusters and form new corresponding clusters.

Pseudocode providing an example of method 700 for extracting representative data from categories according to an embodiment of the present invention is illustrated in FIG. 7B.

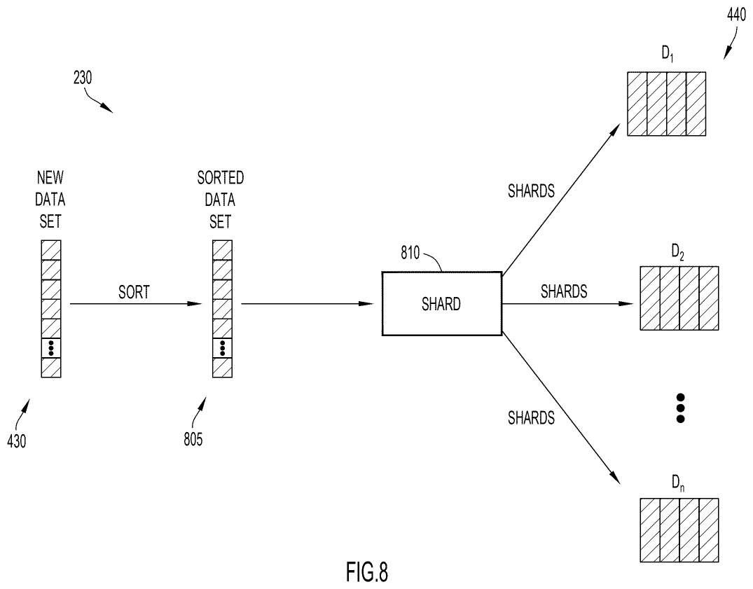

A manner of partitioning representative data of categories into blocks (e.g., via shards module 230, computer 101, etc.) according to an embodiment of the present invention is illustrated in FIG. 8. Initially, partition module 210 partitions or classifies original (training) data into categories or classes, while extract module 220 selects representative data in each category and uses the representative data from the categories to form a new data set 430 in substantially the same manner described above.

Shards module 230 sorts new data set 430 according to a probability of deletion (or sensitivity of data) to form a sorted data set 805. The probability of deletion may be based on the sensitivity of data. For example, sensitive data (e.g., personal information (e.g., personally identifiable information (PII), etc.), financial information, health information (e.g., protected health information (PHI), etc.), confidential or proprietary information, etc.) may be identified and the level of sensitivity determined based on various conventional or other techniques (e.g., natural language processing (NLP), machine learning models, type of data, etc.). The level of sensitivity of data may be mapped or associated with probabilities of deletion, where greater levels of sensitivity are mapped to higher probabilities of deletion. Th level of sensitivity or probability of deletion may be determined based on various factors or metrics (e.g., regulations governing the data, type of security used for the data, type of data, etc.).

Shards module 230 divides sorted data set 805 into blocks (or shards) 440 (e.g., D₁ to Dₙ as viewed in FIG. 8) at flow 810. Sensitive data with high probability of deletion should be allocated to one block as much as possible to reduce the number of repeated training blocks. For example, each data block 440 includes data with a lower probability of deletion than a prior data block 440 (e.g., data block D₁ may contain data with a greatest probability of deletion while data blocks D₂ to Dₙ contain data with successively lower probabilities of deletion (with Dₙ containing data with the lowest probability of deletion)). However, the blocks 440 may be produced in ascending or descending orders of probability of deletion of the data.

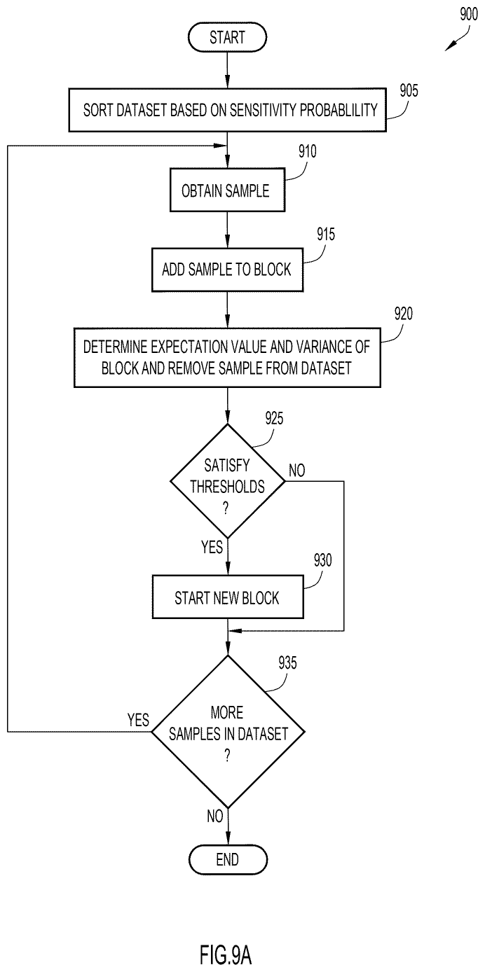

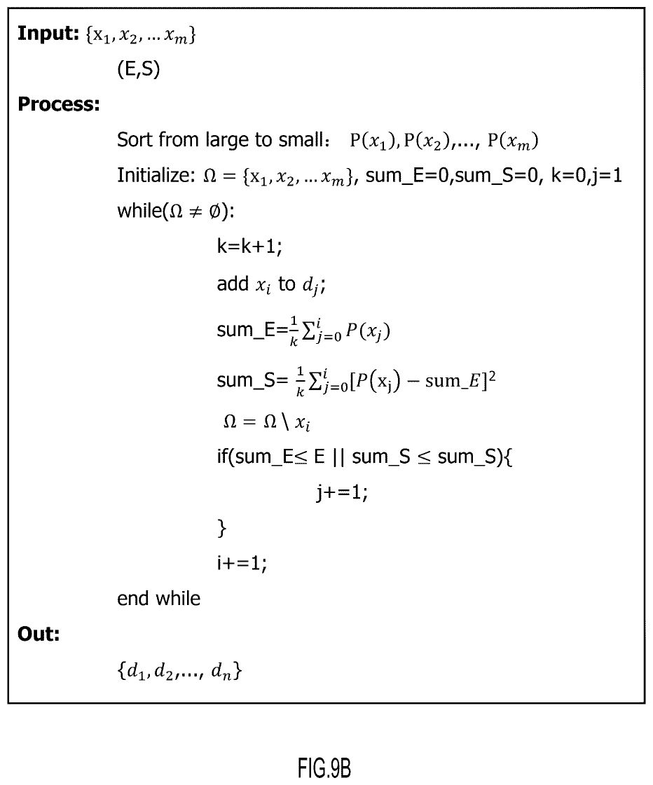

A method 900 of partitioning representative data of categories into blocks (e.g., via shards module 230, computer 101, etc.) according to an embodiment of the present invention is illustrated in FIG. 9A. This may correspond to operation 315 of FIG. 3. Shards module 230 sorts data according to a probability of deletion, and allocates data with a high probability of deletion to a block as much as possible. If the resulting data distribution of blocks is inconsistent, this greatly affects the accuracy of the final machine learning model. Accordingly, shards module 230 ensures that the data distribution of each block is consistent. A mathematical expectation value and variance of data in each block are produced to be consistent to ensure that the data distribution in each block is consistent. Accordingly, corresponding thresholds are used for these values. When the mathematical expectation value and variance of a block reach the corresponding thresholds, a new block is reallocated.

Initially, partition module 210 partitions or classifies original (training) data into clusters representing categories or classes, while extract module 220 selects representative data in each category and uses the representative data from the categories to form a new data set in substantially the same manner described above.

Shards module 230 sorts the new data set according to a probability of deletion (or sensitivity of data) at operation 905. A sample data element is obtained from the sorted data set at operation 910, and the sample data element is added to a block at operation 915. The expectation value and variance for the block are determined at operation 920 based on the probability of deletion of the data, and the sample data element is removed from the data set to avoid reprocessing of the sample data element. For example, the expectation value, E, and variance, S, may be expressed as:

E=1/kΣP(xⱼ) for j=0 to i,

where xⱼ represents a jth data sample, k represents a block number, i represents a data sample number, and P represents the probability of deletion; and
S=1/k Σ[P(xⱼ)−E]² for j=0 to i, where xⱼ represents a jth data sample, k represents a block number, i represents a data sample number, P represents the probability of deletion, and E represents the expectation value described above.

When these values satisfy corresponding thresholds (e.g., less than or equal to the thresholds, etc.) as determined at operation 925, a new block is started at operation 930. The above process is repeated from operation 910 to produce additional blocks until the sorted data set has been processed as determined at operation 935. Sensitive data with high probability of deletion should be allocated to one block as much as possible to reduce the number of repeated training blocks.

Pseudocode providing an example of method 900 for partitioning representative data of categories into blocks according to an embodiment of the present invention is illustrated in FIG. 9B.

By way of example, a data set may include n data elements with k samples (e.g., x₁, x₂, . . . xₖ) having a corresponding probability of deletion (e.g., P(x₁), P(x₂), . . . P(xₖ)).

A request may be received to delete a specific sample, xᵢ. If shards are not used, the amount of data that is needed for retraining the machine learning model may be expressed as (n−i) P(x₁), the number of affected data may be expressed as n−i, and retraining the machine learning model incurs a heavy workload.

However, in the case of using shards (dⱼ) to block the data, the data that is needed for retraining the machine learning model may be expressed as (size (d′j)−i) P(x₁) 1/n, the affected data may be expressed as (size (d′j)−i), and the retraining effort is greatly reduced. However, the sizes of the blocks after division are inconsistent and the probabilities of the blocks are inconsistent. In addition, there are still many samples that lead to retraining within the block.

If distribution occurs after sorting, the expected value is reached and divided into blocks. In this case, data needed for retraining may be expressed as (size (d′j)−i) P(x₁) 1/n, the affected data may be expressed as (size (d′j)−i) inside and outside the block which greatly reduces the workload for retraining. However, the data distribution between blocks is inconsistent which will ultimately affect the consistency of the model.

Accordingly, a present invention embodiment considers both expected value and variance within a block. In this case, data needed for retraining may be expressed as (size (d′j)−i) P(x₁) 1/n, the affected data may be expressed as (size (d′j)−i), the workload of retraining is greatly reduced, and the probability of deleted samples in a specific block is consistent. This approach greatly reduces the workload of retraining inside and outside the block and the data between blocks remains similar step by step, thereby ensuring consistency of the machine learning model.

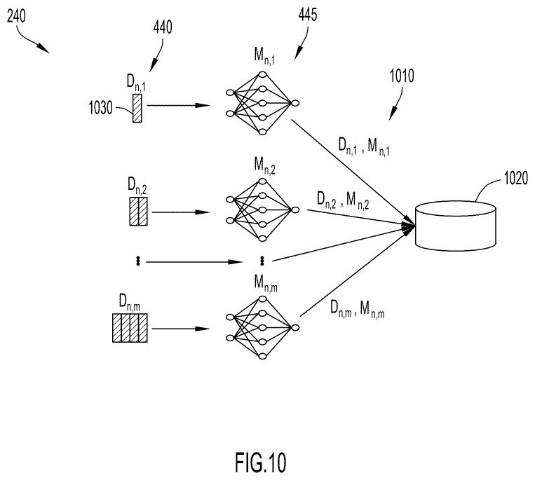

A manner of incremental training of a machine learning model to remove sensitive data (e.g., via incremental training module 240, computer 101, etc.) according to an embodiment of the present invention is illustrated in FIG. 10. This may correspond to operation 320 of FIG. 3. Initially, partition module 210 partitions or classifies original (training) data into categories or classes, while extract module 220 selects representative data in each category and uses the representative data from the categories to form a new data set in substantially the same manner described above. Shards module 230 sorts the new data set according to a probability of deletion (or sensitivity of data) and divides the sorted new data set into blocks (or shards) 440 in substantially the same manner described above.

Incremental training module 240 performs incremental training for machine learning models 445 using data from a corresponding block 440, and stores parameters and the machine learning model of each step of training in a database 1020 (e.g., corresponding to database 130, etc.). During training, the parameters and machine learning model of each slice of a block 440 are saved in database 1020. When retraining is performed, the training is started with data subsequent a corresponding position of data requested to be removed, thereby greatly reducing the data within the block that needs to be used to retrain the machine learning model.

For example, a data block 440 (e.g., Dₙ as viewed in FIG. 10) may be partitioned into segments or slices 1030 of data (e.g., slices 1 to m as viewed in FIG. 10). The slices may contain any desired amount of data. A data set, D_{n,1}, including a first data slice 1030 of a block 440 is used to train a corresponding machine learning model 445 (e.g., M_{n,1} as viewed in FIG. 10). Information 1010 for the resulting parameters and trained machine learning model (e.g., shown as D_{n,1}, M_{n,1} in FIG. 10) is stored in database 1020. A second data set, D_{n,2}, including data slices 1030 from the prior data set (D_{n,1}) and an additional data slice 1030 of the block, is used to train a corresponding machine learning model 445 (e.g., M_{n,2} as viewed in FIG. 10). Information 1010 for the resulting parameters and trained machine learning model (e.g., D_{n,2}, M_{n,2} as viewed in FIG. 10) is stored in database 1020. This process may be repeated until a final data set, D_{n,m}, including all data slices in the block (e.g., data slices from the prior data set (D_{n,m-1}) and an additional slice 1030 of the block), is used to train a corresponding machine learning model 445 (e.g., M_{n,m} as viewed in FIG. 10). Information 1010 for the resulting parameters and trained machine learning model (e.g., D_{n,m}, M_{n,m} as viewed in FIG. 10) is stored in database 1020. Thus, a machine learning model and corresponding parameters are stored for each incremental data set (or data slices of a block) used to train that machine learning model. Each data set incrementally adds an additional data slice of a block for training.

Accordingly, when retraining is performed after removal of sensitive data (e.g., personal information (e.g., personally identifiable information (PII), etc.), financial information, health information (e.g., protected health information (PHI), etc.), confidential or proprietary information, etc.), the training is performed with a machine learning model trained from a block with data prior to the sensitive data to be removed. This machine learning model is retrained starting with data subsequent the corresponding position in the block of the sensitive data requested to be removed (thereby omitting the sensitive data from retraining). This avoids using all of the data of a block to retrain the machine learning model, thereby greatly reducing the amount of data used for training.

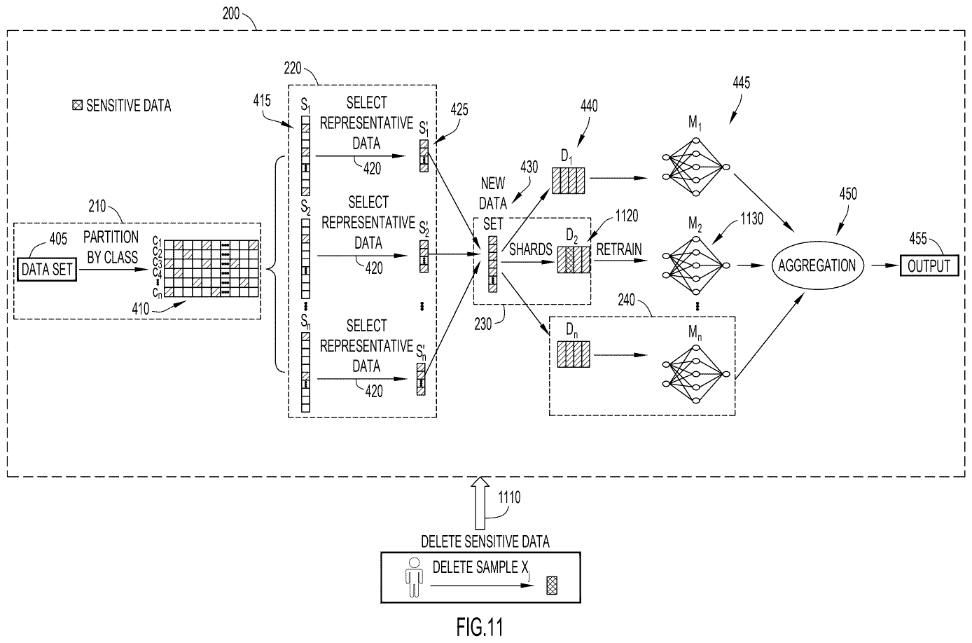

A manner of removing sensitive information from a machine learning model (e.g., via machine learning data protection code 200, computer 101, etc.) according to an embodiment of the present invention is illustrated in FIG. 11. Initially, partition module 210 partitions or classifies original (training) data into categories or classes, while extract module 220 selects representative data in each category and uses the representative data from the categories to form a new data set in substantially the same manner described above. Shards module 230 sorts the new data set according to a probability of deletion (or sensitivity of data) and divides the sorted new data set into blocks (or shards) 440 (e.g., D₁ to Dₙ as viewed in FIG. 11) in substantially the same manner described above. Incremental training module 240 performs incremental training for machine learning models 445 (e.g., M₁ to Mₙ as viewed in FIG. 11) using data from a corresponding block 440, and stores the parameters and machine learning model of each step of training in a database in substantially the same manner described above.

A request 1110 to delete or remove sensitive data 1120 (e.g., personal information (e.g., personally identifiable information (PII), etc.), financial information, health information (e.g., protected health information (PHI), etc.), confidential or proprietary information, etc.) is received, and the location of the sensitive data is identified within a block 440 (e.g., the sensitive data may reside in a second slice of block D₂ as viewed in FIG. 11). When the size of the identified block is the same size as the data to be deleted, the entire data block can be deleted directly (without retraining). In this case, aggregator 450 may combine the information for the machine learning model trained from the remaining blocks. This greatly reduces performance time relative to performance of the technique without shards.

When the size of the identified block is less than the size of the data to be deleted, the location (or slice) containing the data to be deleted is determined and the corresponding parameters and machine learning model 1130 are retrieved from the database. Machine learning model 1130 is trained with data of the identified block prior to the sensitive data requested to be removed. The retraining is started within the block from the location with data subsequent the corresponding position in the identified block of the sensitive data requested to be removed (thereby omitting the sensitive data from retraining). The data for retraining is greatly reduced, and the shard technique ensures consistency to the greatest extent.

For example, machine learning model 1130 and parameters associated with the first slice of block D₂ may be retrieved. This represents a machine learning model trained with the first slice, but not with sensitive data 1120. Sensitive data 1120 may be deleted from the second slice of the block, and retrieved machine learning model 1130 may be trained with remaining data of the data block (e.g., remaining data of the second slice and additional slices of the block).

Machine learning models 445, 1130 are combined or aggregated (e.g., machine learning models, parameters, etc.) by aggregator 450 and the resulting machine learning model (e.g., retrained to remove the sensitive data) is provided as output 455 in substantially the same manner described above. Aggregator 450 may select an appropriate machine learning model, combine weights and/or other parameters of the machine learning models (e.g., average or other statistical measure of the weights or parameters, select min or max values, etc.) to produce a resulting machine learning model having the sensitive data removed.

By way of example, a data set may include N data elements with k samples (e.g., x₁, x₂, . . . xₖ) having a corresponding probability of deletion (e.g., P(x₁), P(x₂), . . . P(xₖ)). A request to delete data may include specific samples (e.g., D={x₁, x₂, . . . xₘ}). The data needed to retrain a machine learning model for a baseline may be expressed as N−size (D), where size (D) represents a number of data elements in D (the data requested to be deleted). In contrast, the data needed to retrain a machine learning model for an embodiment of the present invention may be expressed as size (shards)−size (D)/size (shards), where size (shards) represents a number of data elements in a shard, and size (D) represents a number of data elements in D (the data requested to be deleted). Thus, a present invention embodiment provides reduced retraining time (since only a subset of data is used for retraining) while maintaining high accuracy.

Present invention embodiments provide various technical and other advantages. For example, an embodiment of the present invention alters information learned by a trained machine learning model to remove sensitive or other information (e.g., personal information (e.g., personally identifiable information (PII), etc.), financial information, health information (e.g., protected health information (PHI), etc.), confidential or proprietary information, etc.). Further, a present invention embodiment modifies the training set to produce a small subset for retraining the machine learning model to remove the information. This significantly reduces computing resources and processing time to retrain the machine learning model while maintaining high accuracy.

It will be appreciated that the embodiments described above and illustrated in the drawings represent only a few of the many ways of implementing embodiments for protection of sensitive information in machine learning models.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., machine learning data protection code 200, partition module 210, extract module 220, shards module 230, incremental training module 240, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., data to be deleted, machine learning model parameters, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., data to be deleted, machine learning model parameters, etc.).

The present invention embodiments are not limited to the specific tasks or algorithms described above, but may be utilized for removing any data or information from any type of machine learning model.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
partitioning, via at least one processor, a training data set for a machine learning model into a plurality of categories;
extracting, via the at least one processor, data from the plurality of categories based on density of data elements in the plurality of categories to produce a resulting data set;
dividing, via the at least one processor, the resulting data set into a plurality of blocks based on a probability of deletion of data elements in the resulting data set;
incrementally training, via the at least one processor, the machine learning model using segments from the blocks; and
removing information from the machine learning model, via the at least one processor, by retraining the machine learning model with subsequent data in a corresponding block containing the information to be removed.

2. The method of claim 1, wherein the information removed from the machine learning model includes sensitive data.

3. The method of claim 1, wherein the density of a data element is based on a number of neighboring data elements in a category within a distance of the data element, and the distance is based on maximum and minimum densities within the category.

4. The method of claim 1, wherein dividing the resulting data set into a plurality of blocks comprises:
sorting the resulting data set based on the probability of deletion of the data elements of the resulting data set.

5. The method of claim 4, wherein dividing the resulting data set into a plurality of blocks further comprises:
producing the plurality of blocks from the sorted data set with data elements having an expectation value and variance within corresponding thresholds.

6. The method of claim 1, wherein incrementally training the machine learning model comprises:
training the machine learning model on each segment of a block and storing information including parameters of the machine learning model for each segment.

7. The method of claim 1, wherein retraining the machine learning model comprises:
removing the information from the corresponding block; and
retraining the machine learning model starting from a position in the corresponding block subsequent a position of the information that was removed.

8. A computer system comprising:
a processor set;
one or more computer-readable storage media; and
program instructions stored on the one or more computer-readable storage media to cause the processor set to perform operations comprising:
partitioning a training data set for a machine learning model into a plurality of categories;
extracting data from the plurality of categories based on density of data elements in the plurality of categories to produce a resulting data set;
dividing the resulting data set into a plurality of blocks based on a probability of deletion of data elements in the resulting data set;
incrementally training the machine learning model using segments from the blocks; and
removing information from the machine learning model by retraining the machine learning model with subsequent data in a corresponding block containing the information to be removed.

9. The computer system of claim 8, wherein the density of a data element is based on a number of neighboring data elements in a category within a distance of the data element, and the distance is based on maximum and minimum densities within the category.

10. The computer system of claim 8, wherein dividing the resulting data set into a plurality of blocks comprises:
sorting the resulting data set based on the probability of deletion of the data elements of the resulting data set.

11. The computer system of claim 10, wherein dividing the resulting data set into a plurality of blocks further comprises:
producing the plurality of blocks from the sorted data set with data elements having an expectation value and variance within corresponding thresholds.

12. The computer system of claim 8, wherein incrementally training the machine learning model comprises:
training the machine learning model on each segment of a block and storing information including parameters of the machine learning model for each segment.

13. The computer system of claim 8, wherein retraining the machine learning model comprises:
removing the information from the corresponding block; and
retraining the machine learning model starting from a position in the corresponding block subsequent a position of the information that was removed.

14. A computer program product comprising:
one or more computer-readable storage media; and
program instructions stored on the one or more computer-readable storage media to perform operations comprising:
partitioning a training data set for a machine learning model into a plurality of categories;
extracting data from the plurality of categories based on density of data elements in the plurality of categories to produce a resulting data set;
dividing the resulting data set into a plurality of blocks based on a probability of deletion of data elements in the resulting data set;
incrementally training the machine learning model using segments from the blocks; and
removing information from the machine learning model by retraining the machine learning model with subsequent data in a corresponding block containing the information to be removed.

15. The computer program product of claim 14, wherein the information removed from the machine learning model includes sensitive data.

16. The computer program product of claim 14, wherein the density of a data element is based on a number of neighboring data elements in a category within a distance of the data element, and the distance is based on maximum and minimum densities within the category.

17. The computer program product of claim 14, wherein dividing the resulting data set into a plurality of blocks comprises:
sorting the resulting data set based on the probability of deletion of the data elements of the resulting data set.

18. The computer program product of claim 17, wherein dividing the resulting data set into a plurality of blocks further comprises:
producing the plurality of blocks from the sorted data set with data elements having an expectation value and variance within corresponding thresholds.

19. The computer program product of claim 14, wherein incrementally training the machine learning model comprises:
training the machine learning model on each segment of a block and storing information including parameters of the machine learning model for each segment.

20. The computer program product of claim 14, wherein retraining the machine learning model comprises:
removing the information from the corresponding block; and
retraining the machine learning model starting from a position in the corresponding block subsequent a position of the information that was removed.
